(19) United States
(12) Patent Application Publication
(10) Pub. No.: US 2024/0404813 A1
(43) Pub. Date: Dec. 5, 2024

(54) METHOD FOR ENHANCING INFORMATION IN DDA MASS SPECTROMETRY

(71) Applicant: DH Technologies Development Pte. Ltd., Singapore (SG)

(72) Inventor: Stephen A. TATE, Ontario (CA)

(21) Appl. No.: 18/686,385

(22) PCT Filed: Aug. 16, 2022
(86) PCT No.: PCT/IB2022/057680

§ 371 Date: Feb. 23, 2024

Related U.S. Application Data
(60) Provisional application No. 63/237,149, filed on Aug. 26, 2021.

(51) Int. Cl. H01J 49/00; H01J 49/40; H01J 49/42

(52) U.S. Cl. CPC H01J 49/0045; H01J 49/0031; H01J 49/40; H01J 49/4215

(57) ABSTRACT

Systems and methods are disclosed for performing a DDA mass spectrometry experiment. A precursor ion survey scan of a mass range is performed to generate a precursor ion peak list. A series of steps are performed for each precursor ion peak of the peak list. A peak mass range including the precursor ion peak is selected. A precursor ion mass selection window with a width smaller than the peak mass range is canned across the peak mass range in overlapping steps, producing a series of overlapping windows across the peak mass range. Each overlapping precursor ion mass selection window of the series is fragmented. Product ions produced from each overlapping precursor ion mass selection window of the series are mass analyzed, producing a product ion spectrum for each overlapping precursor ion mass selection window of the series and a plurality of product ion spectra for the peak.

### RELATED APPLICATIONS

This application claims the benefit of U.S. Provisional Patent Application Ser. No. 63/237,149, filed on Aug. 26, 2021, the content of which is incorporated by reference herein in its entirety.

### INTRODUCTION

The teachings herein relate to systems and methods for performing a data-dependent acquisition (DDA) mass spectrometry experiment. More particularly the teachings herein relate to systems and methods in which the isolation and fragmentation of a precursor ion in the DDA method are performed by scanning a precursor ion mass selection window across a narrow peak mass range in overlapping steps. Precursor ion and product ion relationships are deconvolved from the series of overlapping precursor ion mass selection windows in a single time cycle.

The systems and methods herein can be performed in conjunction with a processor, controller, or computer system, such as the computer system of FIG. 1.

### Co-Isolated Precursor Ion Masses in DDA

As described below, data-dependent acquisition (DDA) is an untargeted acquisition method and can also be referred to as information-dependent acquisition (IDA). The terms DDA and IDA are used interchangeably throughout this written description to refer to the same type of acquisition method.

Also as described below, in a DDA method, a precursor ion or mass spectrometry (MS) survey scan of a mass range is performed to generate a precursor ion peak list. MS/MS is then performed on each precursor ion of the peak list or a subset of the peak list. Each precursor ion of the peak list is isolated and fragmented using a narrow precursor ion mass selection window around the precursor ion, for example. A product ion spectrum is produced for each precursor ion.

Currently, DDA methods rely upon the fact that the narrow precursor ion mass selection window isolates a single precursor ion representing a single compound for fragmentation. In modern mass spectrometers, however, the sensitivity is such that a number of precursor ions representing different compounds can be measured near the same mass and then co-isolated for fragmentation.

DDA is a method in which a single product ion spectrum is used for identification of the compound (precursor ion). If the product ion spectrum contains product ions from more than one precursor ion, the precursor ion and product ion relationships must be deconvolved. If product ion spectra are collected over time, for example, these relationships can be deconvolved using the known retention times of known compounds. Unfortunately, however, there is no method and insufficient data to deconvolve the precursor ion and product ion relationships in the same time cycle.

As a result, there is a need for systems and methods that can deconvolve the precursor ion and product ion relationships in a product ion spectrum of a DDA method in a single time cycle.

### Tandem Mass Spectrometry Background

In general, tandem mass spectrometry, or mass spectrometry/mass spectrometry (MS/MS), is a well-known technique for analyzing compounds. Tandem mass spectrometry involves ionization of one or more compounds from a sample, selection of one or more precursor ions of the one or more compounds, fragmentation of the one or more precursor ions into fragment or product ions, and mass analysis of the product ions.

Tandem mass spectrometry can provide both qualitative and quantitative information. The product ion spectrum can be used to identify a molecule of interest. The intensity of one or more product ions can be used to quantitate the amount of the compound present in a sample.

A large number of different types of experimental methods or workflows can be performed using a tandem mass spectrometer. Three broad categories of these workflows are, targeted acquisition, information dependent acquisition (IDA) or data-dependent acquisition (DDA), and data-independent acquisition (DIA).

In a targeted acquisition method, one or more transitions of a precursor ion to a product ion are predefined for a compound of interest. As a sample is being introduced into the tandem mass spectrometer, the one or more transitions are interrogated during each time period or cycle of a plurality of time periods or cycles. In other words, the mass spectrometer selects and fragments the precursor ion of each transition and performs a targeted mass analysis for the product ion of the transition. As a result, an intensity (a product ion intensity) is produced for each transition. Targeted acquisition methods include, but are not limited to, multiple reaction monitoring (MRM) and selected reaction monitoring (SRM).

In an IDA method, a user can specify criteria for performing an untargeted mass analysis of product ions, while a sample is being introduced into the tandem mass spectrometer. For example, in an IDA method a precursor ion or mass spectrometry (MS) survey scan is performed to generate a precursor ion peak list. The user can select criteria to filter the peak list for a subset of the precursor ions on the peak list. MS/MS is then performed on each precursor ion of the subset of precursor ions. A product ion spectrum is produced for each precursor ion. MS/MS is repeatedly performed on the precursor ions of the subset of precursor ions as the sample is being introduced into the tandem mass spectrometer.

In proteomics and many other sample types, however, the complexity and dynamic range of compounds are very large. This poses challenges for traditional targeted and IDA methods, requiring very high-speed MS/MS acquisition to deeply interrogate the sample in order to both identify and quantify a broad range of analytes.

As a result, DIA methods, the third broad category of tandem mass spectrometry, were developed. These DIA methods have been used to increase the reproducibility and comprehensiveness of data collection from complex samples. DIA methods can also be called non-specific fragmentation methods. In a traditional DIA method, the actions of the tandem mass spectrometer are not varied among MS/MS scans based on data acquired in a previous precursor or product ion scan. Instead, a precursor ion mass range is selected. A precursor ion mass selection window is then stepped across the precursor ion mass range. All precursor ions in the precursor ion mass selection window are fragmented and all of the product ions of all of the precursor ions in the precursor ion mass selection window are mass analyzed.

The precursor ion mass selection window used to scan the mass range can be very narrow so that the likelihood of multiple precursors within the window is small. This type of DIA method is called, for example, MS/MS^{ALL}. In an MS/MS^{ALL} method, a precursor ion mass selection window of about 1 amu is scanned or stepped across an entire mass range. A product ion spectrum is produced for each 1 amu precursor mass window. The time it takes to analyze or scan the entire mass range once is referred to as one scan cycle. Scanning a narrow precursor ion mass selection window across a wide precursor ion mass range during each cycle, however, is not practical for some instruments and experiments.

As a result, a larger precursor ion mass selection window, or selection window with a greater width, is stepped across the entire precursor mass range. This type of DIA method is called, for example, SWATH acquisition. In a SWATH acquisition, the precursor ion mass selection window stepped across the precursor mass range in each cycle may have a width of 5-25 amu, or even larger. Like the MS/MS^{ALL} method, all the precursor ions in each precursor ion mass selection window are fragmented, and all of the product ions of all of the precursor ions in each mass selection window are mass analyzed. However, because a wider precursor ion mass selection window is used, the cycle time can be significantly reduced in comparison to the cycle time of the MS/MS^{ALL} method. Or, for liquid chromatography (LC), the accumulation time can be increased. Generally, for LC, the cycle time is defined by an LC peak. Enough points (intensities as a function of cycle time) must be obtained across an LC peak to determine its shape. When the cycle time is defined by the LC, the number of experiments or mass spectrometry scans that can be performed in a cycle defines how long each experiment or scan can accumulate ion observations. As a result, using a wider precursor ion mass selection window can increase the accumulation time.

U.S. Pat. No. 8,809,770 describes how SWATH acquisition can be used to provide quantitative and qualitative information about the precursor ions of compounds of interest. In particular, the product ions found from fragmenting a precursor ion mass selection window are compared to a database of known in product ions of compounds of interest. In addition, ion traces or extracted ion chromatograms (XICs) of the product ions found from fragmenting a precursor ion mass selection window are analyzed to provide quantitative and qualitative information.

However, identifying compounds of interest in a sample analyzed using SWATH acquisition, for example, can be difficult. It can be difficult because either there is no precursor ion information provided with a precursor ion mass selection window to help determine the precursor ion that produces each product ion, or the precursor ion information provided is from a mass spectrometry (MS) observation that has a low sensitivity. In addition, because there is little or no specific precursor ion information provided with a precursor ion mass selection window, it is also difficult to determine if a product ion is convolved with or includes contributions from multiple precursor ions within the precursor ion mass selection window.

### Scanning SWATH Background

As a result, a method of scanning the precursor ion mass selection windows in SWATH acquisition, called scanning SWATH, was developed. Essentially, in scanning SWATH, a precursor ion mass selection window is scanned across a mass range so that successive windows have large areas of overlap and small areas of non-overlap. This scanning makes the resulting product ions a function of the scanned precursor ion mass selection windows. This additional information, in turn, can be used to identify the one or more precursor ions responsible for each product ion.

Scanning SWATH has been described in International Publication No. WO 2013/171459 A2 (hereinafter “the '459 Application”). In the '459 Application, a precursor ion mass selection window or precursor ion mass selection window of 25 Da is scanned with time such that the range of the precursor ion mass selection window changes with time. The timing at which product ions are detected is then correlated to the timing of the precursor ion mass selection window in which their precursor ions were transmitted.

The correlation is done by first plotting the mass-to-charge ratio (m/z) of each product ion detected as a function of the precursor ion m/z values transmitted by the quadrupole mass filter. Since the precursor ion mass selection window is scanned over time, the precursor ion m/z values transmitted by the quadrupole mass filter can also be thought of as times. The start and end times at which a particular product ion is detected are correlated to the start and end times at which its precursor is transmitted from the quadrupole. As a result, the start and end times of the product ion signals are used to determine the start and end times of their corresponding precursor ions.

Scanning SWATH has also been described in U.S. Pat. No. 10,068,753 (hereinafter “the '753 patent”). The '753 patent improves the accuracy of the correlation of product ions to their corresponding precursor ions by combining product ion spectra from successive groups of the overlapping rectangular precursor ion mass selection windows. Product ion spectra from successive groups are combined by successively summing the intensities of the product ions in the product ion spectra. This summing produces a function that can have a shape that is non-constant with precursor mass. The shape describes product ion intensity as a function of precursor mass. A precursor ion is identified from the function calculated for a product ion.

Systems and methods for identifying one or more precursor ions corresponding to a product ion in scanning SWATH data are further described in U.S. Pat. No. 10,651,019 (hereinafter “the '019 patent”). Scanning SWATH is performed, producing a series of overlapping windows across the precursor ion mass range. Each overlapping window is fragmented and mass analyzed, producing a plurality of product ion spectra for the mass range. A product ion is selected from the spectra. Intensities for the selected product ion are retrieved for at least one scan across the mass range producing a trace of intensities versus precursor ion m/z. A matrix multiplication equation is created that describes how one or more precursor ions correspond to the trace for the selected product ion. The matrix multiplication equation is solved for one or more precursor ions corresponding to the selected product ion using a numerical method.

As described above, SWATH is a tandem mass spectrometry technique that allows a mass range to be scanned within a time interval using multiple precursor ion scans of adjacent or overlapping precursor ion mass selection windows. A mass filter selects each precursor mass window for fragmentation. A high-resolution mass analyzer is then used to detect the product ions produced from the fragmentation of each precursor mass window. SWATH allows the sensitivity of precursor ion scans to be increased without the traditional loss in specificity.

Unfortunately, however, the increased sensitivity that is gained through the use of sequential precursor mass windows in the SWATH method is not without cost. Each of these precursor mass windows can contain many other precursor ions, which confounds the identification of the correct precursor ion for a set of product ions. Essentially, the exact precursor ion for any given product ion can only be localized to a precursor mass window.

FIG. 2 is an exemplary plot 200 of a single precursor ion mass selection window that is typically used in a SWATH acquisition. Precursor ion mass selection window 210 transmits precursor ions with m/z values between M₁ and M₂, has set mass or center mass 215, and has sharp vertical edges 220 and 230. The SWATH precursor ion mass selection window width is M₂−M₁. The rate at which precursor ion mass selection window 210 transmits precursor ions is constant with respect to precursor m/z. Note that one skilled in the art can appreciate that the terms “m/z” and “mass” can be used interchangeably. The mass is easily obtained from the m/z value by multiplying the m/z value by the charge.

FIG. 3 is an exemplary series 300 of plots showing how product ions are correlated to precursor ions in conventional SWATH. Plot 310 shows a precursor ion mass range from 100 m/z to 300 m/z. When this precursor ion mass range is mass filtered and analyzed using a precursor ion scan, the precursor ion mass spectrum shown in plot 310 is found. The precursor ion mass spectrum includes precursor ion peaks 311, 312, 313, and 314, for example.

In conventional SWATH acquisition, a series of precursor ion mass selection windows, like precursor ion mass selection window 210 of FIG. 2, are selected across a precursor ion mass range. For example, ten precursor ion mass selection windows each of width 20 m/z can be selected for the precursor ion mass range from 100 m/z to 300 m/z shown in plot 310 of FIG. 3. Plot 320 shows three of the 10 precursor ion mass selection windows, 321, 322, and 323, for the precursor ion mass range from 100 m/z to 300 m/z. Note that the precursor ion mass selection windows of plot 320 do not overlap. In other conventional SWATH scans, the precursor ion mass selection windows can overlap.

For each conventional SWATH scan, the precursor ion mass selection windows are sequentially fragmented and mass analyzed. As a result, for each scan, a product ion spectrum is produced for each precursor ion mass selection window. Plot 331 is the product ion spectrum produced for precursor ion mass selection window 321 of plot 320. Plot 332 is the product ion spectrum produced for precursor ion mass selection window 322 of plot 320. And, plot 333 is the product ion spectrum produced for precursor ion mass selection window 323 of plot 320.

The product ions of a conventional SWATH are correlated to precursor ions by locating the precursor ion mass selection window of each product ion, and determining the precursor ions of the precursor ion mass selection window from the precursor ion spectrum obtained from a precursor ion scan. For example, product ions 341, 342, and 343 of plot 331 are produced by fragmenting precursor ion mass selection window 321 of plot 320. Based on its location in the precursor ion mass range and the results from a precursor ion scan, precursor ion mass selection window 321 is known to include precursor ion 311 of plot 310. Since precursor ion 311 is the only precursor ion in precursor ion mass selection window 321 of plot 320, product ions 341, 342, and 343 of plot 331 are correlated to precursor ion 311 of plot 310.

Similarly, product ion 361 of plot 333 is produced by fragmenting precursor ion mass selection window 323 of plot 320. Based on its location in the precursor ion mass range and the results from a precursor ion scan, precursor ion mass selection window 323 is known to include precursor ion 314 of plot 310. Since precursor ion 314 is the only precursor ion in precursor ion mass selection window 323 of plot 320, product ion 361 is correlated to precursor ion 314 of plot 310.

The correlation, however, becomes more difficult when a precursor ion mass selection window includes more than one precursor ion and those precursor ions may produce the same or a similar product ion. In other words, when interfering precursor ions occur in the same precursor ion mass selection window, it is not possible to correlate the common product ions to the interfering precursor ions without additional information.

For example, product ions 351 and 352 of plot 332 are produced by fragmenting precursor ion mass selection window 322 of plot 320. Based on its location in the precursor ion mass range and the results from a precursor ion scan, precursor ion mass selection window 322 is known to include precursor ions 312 and 313 of plot 310. As a result, product ions 351 and 352 of plot 332 can be from precursor ion 312 or 313 of plot 310. Further, precursor ions 312 and 313 may both be known to produce a product ion at or near the m/z of product ion 351. In other words, both precursor ions may provide contributions to product ion peak 351. As a result, the correlation of a product ion to a precursor ion or to a specific contribution from a precursor ion is made more difficult.

In conventional SWATH acquisition, chromatographic peaks, such as LC peaks, can also be used to improve the correlation. In other words, the compound of interest is separated over time and the SWATH acquisition is performed at a plurality of different elution or retention times. The retention times and/or the shapes of product and precursor ion chromatographic peaks are then compared to enhance the correlation. Unfortunately, however, because the sensitivity of the precursor ion scan is low, the chromatographic peaks of precursor ions may be convolved, further confounding the correlation.

In various embodiments, scanning SWATH provides additional information that is similar to that provided by chromatographic peaks, but with enhanced sensitivity. In scanning SWATH, overlapping precursor ion mass selection windows are used to correlate precursor and product ions. For example, a single precursor ion mass selection window such as precursor ion mass selection window 210 of FIG. 2 is shifted in small steps across a precursor mass range so that there is a large overlap between successive precursor ion mass selection windows. As the amount of overlap between precursor ion mass selection windows is increased, the accuracy in correlating the product ions to precursor ions is also increased.

Essentially, when the intensities of product ions produced from precursor ions filtered by the overlapping precursor ion mass selection windows are plotted as a function of the precursor ion mass selection window moving across the precursor mass range, each product ion has an intensity for the same precursor mass range that its precursor ion has been transmitted. In other words, for a rectangular precursor ion mass selection window (such as precursor ion mass selection window 210 of FIG. 2) that transmits precursor ions at a constant rate with respect to precursor mass, the edges (such as edges 220 and 230 of FIG. 2) define a unique boundary of both precursor ion precursor ion mass selection and product ion intensity as the precursor ion mass selection is stepped across the precursor mass range.

FIG. 4 is an exemplary plot 400 of a precursor ion mass selection window 410 that is shifted or scanned across a precursor ion mass range in order to produce overlapping precursor ion mass selection windows. Precursor ion mass selection window 410, for example, starts to transmit precursor ion with m/z value 420 when leading edge 430 reaches precursor ion with m/z value 420. As precursor ion mass selection window 410 is shifted across the m/z range, the precursor ion with m/z value 420 is transmitted until trailing edge 440 reaches m/z value 420. When the intensities of the product ions from the product ion spectra produced by the overlapping windows are plotted, for example, as a function of the m/z value of leading edge 430, any product ion produced by the precursor ion with m/z value 420 would have an intensity between m/z value 420 and m/z value 450 of leading edge 430. One skilled in the art can appreciate that the intensities of the product ions produced by the overlapping windows can be plotted as a function of the precursor ion m/z value based on any parameter of precursor ion mass selection window 410 including, but not limited to, trailing edge 440, set mass, center of gravity, or leading edge 430.

FIG. 5 is an exemplary series 500 of plots showing how product ions are correlated to precursor ions in scanning SWATH. Plot 510 is the same as plot 310 of FIG. 3. Plot 510 of FIG. 5 shows a precursor ion mass range from 100 m/z to 300 m/z. When this precursor ion mass range is mass filtered and analyzed using a precursor ion scan, the precursor ion mass spectrum shown in plot 510 is found. The precursor ion mass spectrum includes precursor ion peaks 311, 312, 313, and 314, for example.

In scanning SWATH, however, rather than selecting and then fragmenting and mass analyzing non-overlapping precursor ion mass selection windows across the mass range, a precursor ion mass selection window is quickly moved or scanned across the precursor ion mass range with large overlaps between windows in each scanning SWATH scan. For example, during scan 1, precursor ion mass selection window 521 of plot 520 extends from 100 m/z to 120 m/z. The fragmentation of precursor ion mass selection window 521 and mass analysis of the resulting fragments during scan 1 produces the product ions of plot 531. Product ions 541, 542, and 543 of plot 531 are known to correlate to precursor ion 311 of plot 510, because precursor ion 311 is the only precursor within precursor ion mass selection window 521 of plot 520. Note that plot 531 includes the same product ions as plot 331 of FIG. 3.

For scan 2, precursor ion mass selection window 521 is shifted 1 m/z as shown in plot 530. Precursor ion mass selection window 521 of plot 530 no longer includes precursor ion 311 of plot 510. However, precursor ion mass selection window 521 of plot 530 now includes precursor ion 312 of plot 510. The fragmentation of precursor ion mass selection window 521 and mass analysis of the resulting fragments during scan 2 produces the product ion of plot 532. Product ion 551 of plot 532 is known to correlate to precursor ion 312 of plot 510, because precursor ion 312 is the only precursor within precursor ion mass selection window 521 of plot 530. Note that product ion 551 of plot 532 has the same m/z value as product ion 351 of plot 332 of FIG. 3, but a different intensity. From plot 532 of FIG. 5, it is now known what portion of 351 of plot 332 of FIG. 3 is from precursor ion 312 of plot 510.

For scan 3, precursor ion mass selection window 521 is shifted another 1 m/z as shown in plot 540. Precursor ion mass selection window 521 of plot 540 now includes precursor ions 312 and 313 of plot 510. The fragmentation of precursor ion mass selection window 521 and mass analysis of the resulting fragments during scan 3 produces the product ions of plot 533. Because precursor ion mass selection window 521 of plot 540 includes precursor ions 312 and 313 of plot 510, product ions 551 and 552 of plot 533 can be from either or both precursor ions.

Note that plot 533 includes the same product ions as plot 332 of FIG. 3. However, due to the additional information from scanning SWATH correlation is now possible. As mentioned above, from plot 532 of FIG. 5, it is now known what portion of 351 of plot 332 of FIG. 3 is from precursor ion 312 of plot 510. In other words, when the leading edges of precursor ion mass selection window 521 reaches precursor ion 312 of plot 510 and the trailing edges of precursor ion mass selection window 521 no longer includes precursor ion 312 of plot 510, the contribution of precursor ion 312 of plot 510 is known.

In addition, comparing plots 532 and 533 of FIG. 5 determines the contributions of precursor ion 313 of plot 510. Note that once the leading edge of precursor ion mass selection window 521 reaches precursor ion 313 of plot 510, product ion 552 of plot 533 appears and the intensity of product ion 551 increases. Thus product ion 552 is correlated to precursor ion 313 of plot 510 and the additional intensity of product ion 551 is also correlated to precursor ion 313 of plot 510.

FIG. 6 is a diagram 600 showing how a product ion produced from a precursor ion that is filtered by overlapping precursor ion mass selection windows in a scanning SWATH acquisition can be plotted as a function of the precursor ion mass selection window moving across the precursor mass range. Plot 610 shows that there is a precursor ion 620 at m/z 630. Precursor ion mass selection window 641 is stepped across the precursor ion mass range from m/z 631 to m/z 633, resulting in overlapping rectangular precursor ion mass selection windows 640. Each window of precursor ion mass selection windows 640 is fragmented. The resulting product ions are then mass analyzed, producing a product ion mass spectrum (not shown) for each window of precursor ion mass selection windows 640.

FIG. 6 shows just one scan of precursor ion mass selection window 641 across precursor ion mass range from m/z 631 to m/z 633. However, precursor ion mass selection window 641 can be scanned across the precursor ion mass range from m/z 631 to m/z 633 multiple times, for example.

A product ion is selected from one of the product ion spectra produced. A product ion is selected, for example, that has a mass peak above a certain threshold.

The intensity of the product ion is then calculated as a function of the position of precursor ion mass selection window 641 by obtaining the intensity of the product ion from each product ion spectrum produced for each precursor ion mass selection window of precursor ion mass selection windows 640. The intensity of a selected product ion calculated as a function of the position of the precursor ion mass selection window can be called, for example, a quadrupole ion trace (QIT).

An exemplary QIT 660 calculated for a product ion is shown in plot 650. QIT 660 shows the intensities of the selected product ion obtained from each product ion spectrum produced for each precursor ion mass selection window of precursor ion mass selection windows 640. The intensities are plotted as a function of the leading edge of precursor ion mass selection windows 640. However, as described above, these intensities can be plotted as a function of any parameter of precursor ion mass selection windows 640 including, but not limited to, the trailing edge, set mass, leading edge, or scan time.

QIT 660 of plot 650 shows that the intensity of the selected product ion becomes non-zero when the leading edge of scanning precursor ion mass selection window 641 reaches m/z 630. It also shows that the intensity of the product ion returns to zero when the leading edge of the scanning precursor ion mass selection window passes m/z 632. In other words, QIT 660 has sharp leading and trailing edges corresponding to locations of scanning precursor ion mass selection window 641.

FIG. 6, shows that the leading and trailing edges of QIT 660 can be used to determine the corresponding precursor ion of the selected product ion. Essentially, the leading and trailing edges of QIT 660 mean that the precursor ion of the selected product ion must be in the precursor ion mass selection windows between these edges. Precursor ion mass selection windows 645 of precursor ion mass selection windows 640 have leading edges within these windows. Plot 610 shows that precursor ion 620 is the only precursor ion that can be in precursor ion mass selection windows 645. Therefore, the selected product ion with QIT 660 corresponds to precursor ion 620.

This leading and trailing edge analysis of a QIT was described in the '459 Application. Unfortunately, there are two problems with this type of analysis. First, as the '753 patent describes, most mass filters are unable to produce precursor ion mass selection windows with sharply defined edges. As a result, a calculated QIT is likewise unlikely to have sharply defined edges. Secondly, the product ion may be a result of two or more different precursor ions that have similar masses. In other words, the product ion intensity may be a convolution intensities produced from two or more interfering precursor ions.

FIG. 7 is a plot 700 of an exemplary quadrupole ion trace (QIT) calculated for a selected product ion that is produced from two interfering precursor ions using data from an actual scanning SWATH experiment. A comparison of plot 700 with plot 650 of FIG. 6 shows that an actual QIT does not have sharply defined edges. The comparison also shows the multiple levels of intensities caused by the two interfering precursor ions further complicates the determination of the corresponding precursor ions. As a result, methods other than simple edge detection are needed to accurately determine the corresponding precursor ions from a product ion QIT.

In the '019 patent, the corresponding precursor ions are determined from a product ion QIT using a system of linear equations. For example, each step of the precursor ion mass selection window across the mass range is represented by a linear equation. The unknown variables of each linear equation are the intensities of the precursor ion m/z values across the precursor ion mass range. The coefficients of each linear equation specify the position of the precursor ion mass selection window. The result of each equation is the value of the QIT at that particular step of the precursor ion mass selection window across the mass range. The corresponding precursor ions of a product ion QIT are found by solving the system of linear equations for the precursor ion intensity values across the precursor ion mass range (the unknown variables).

In various embodiments, the system of linear equations used to determine the corresponding precursor ions of a product ion QIT is represented as a matrix multiplication equation. For example, an n×m matrix is multiplied by a column matrix of length m producing a column matrix of length n. The n×m matrix represents the mass filter. The rows, n, are the locations of the precursor ion mass selection window across the precursor ion mass range. The columns, m, are the precursor ion m/z values across the precursor ion mass range. The elements of the n×m matrix represent the transmission (1) or non-transmission (0) by the precursor ion mass selection window at that location and precursor ion m/z value. The elements are known from the acquisition. This is how the mass filter scans the precursor ion mass selection window across the precursor ion mass range.

The rows, m, of the column matrix of length m correspond to the columns of the n×m matrix and are the precursor ion m/z values across the precursor ion mass range. The elements of the column matrix of length m are the intensities of the precursor ions at the precursor ion m/z value. These elements are unknown.

The rows, n, of the column matrix of length n correspond to the rows of the n×m matrix and are the locations of the precursor ion mass selection window across the precursor ion mass range. The elements of the column matrix of length n are the intensities of the product ion at locations of the precursor ion mass selection window across the precursor ion mass range that are known from the QIT calculated for a particular acquisition.

FIG. 8 is a diagram 800 showing a simplified example of how corresponding precursor ions are determined from a product ion QIT using a system of linear equations represented by a matrix multiplication equation. Plot 810 shows how precursor ion mass selection window 841 is scanned across a precursor ion mass range from an m/z of 1 to an m/z of 5. Precursor ions 821 and 822 are unknown.

A product ion is selected from the product ion spectra produced from scanning precursor ion mass selection window 841 across the precursor ion mass range from an m/z of 1 to an m/z of 5, fragmenting each window, and mass analyzing the product ions produced for each window. QIT 860 of plot 850 is the QIT calculated for the selected product ion. As described above, the actual QIT of the selected product ion will not have the sharp edges of QIT 860. In fact, the actual QIT of the selected product ion will look much more like QIT 510 of FIG. 5. However, QIT 860 is drawn with sharp edges to simplify the example.

In order to determine the precursor ions corresponding to QIT 860 a system of linear equations is calculated. This system is represented in the form of matrix multiplication equation 870. In equation 870, 9×5 mass filter matrix 871 is multiplied by precursor ion column matrix 872 of length 5 producing QIT column matrix 873 of length 9. The elements of mass filter matrix 871 are known from movements of precursor ion mass selection window 841 during the scan across the precursor ion mass range. QIT column matrix 873 is also known. It is calculated from the product ion spectra produced. Precursor ion column matrix 872 is unknown.

In various embodiments, a numerical method is applied to matrix multiplication equation 870 to solve for precursor ion column matrix 872. The solution for precursor ion column matrix 872 determines the corresponding precursor ions for QIT 860. For example, the solution for precursor ion column matrix 872 shows that the selected product ion with QIT 860 was produced from a precursor ion with intensity 2 at 2 m/z and a precursor ion with intensity 1 at 3 m/z. These precursor ions are ions 821 and 822, respectively, shown in plot 810.

In various embodiments, the numerical method applied to matrix multiplication equation 870 is non-negative least squares (NNLS).

FIG. 9 is an exemplary matrix multiplication equation 900 showing an experimental example of how corresponding precursor ions are determined from a product ion QIT. Matrix multiplication equation 900 includes quadrupole 1 (Q1) mass filter matrix 971, precursor ion column matrix 972, and QIT column matrix 973. Q1 mass filter matrix 971 is known from the acquisition and describes how the Q1 mass filter scan operates. Note that Q1 mass filter matrix 971 includes non-zero values along diagonal 980, corresponding to the sliding precursor ion mass selection window of scanning SWATH™.

QIT column matrix 973 includes the known or observed product ion intensities of the selected product ion as a function of Q1 or precursor ion mass or m/z. QIT column matrix 973 is represented in FIG. 9 by actual calculated QIT 990.

Precursor ion column matrix 972 is the unknown. Matrix multiplication equation 900 is solved for precursor ion column matrix 972. Precursor ion column matrix 972 includes the intensities of the precursor ions corresponding to the product ion for which QIT column matrix 973 is calculated. Precursor ion column matrix 972 is represented in FIG. 9 by a precursor ion spectrum that can be produced from precursor ion column matrix 972. When matrix multiplication equation 900 is solved, precursor ions 921 and 922 are found to correspond to QIT 990. Matrix multiplication equation 900 is solved using the NNLS numerical method.

### SUMMARY

A system, method, and computer program product are disclosed for performing a DDA mass spectrometry experiment. The system includes an ion source device, a tandem mass spectrometer, and a processor. The tandem mass spectrometer includes a mass filter, a fragmentation device, and a mass analyzer.

The ion source device transforms a sample or compounds of interest from a sample into an ion beam. The tandem mass spectrometer creates precursor ion peak list of a DDA experiment. It does this by transmitting a mass range of precursor ions from the ion beam, measuring a precursor ion mass spectrum for the mass range using the mass analyzer, and selecting one or more peaks of the mass spectrum for the peak list.

For each precursor ion peak of the peak list, the tandem mass spectrometer performs a number of steps. First, the tandem mass spectrometer selects a peak mass range including the precursor ion peak. Second, the tandem mass spectrometer scans a precursor ion mass selection window with a width smaller than the peak mass range across the peak mass range in overlapping steps using the mass filter, producing a series of overlapping precursor ion mass selection windows across the peak mass range. Third, the tandem mass spectrometer fragments each overlapping precursor ion mass selection window of the series using the fragmentation device. Finally, the tandem mass spectrometer mass analyzes product ions produced from each overlapping precursor ion mass selection window of the series using the mass analyzer. A product ion spectrum for each overlapping precursor ion mass selection window of the series is produced and a plurality of product ion spectra are produced for the peak.

These and other features of the applicant's teachings are set forth herein.

### BRIEF DESCRIPTION OF THE DRAWINGS

The skilled artisan will understand that the drawings, described below, are for illustration purposes only. The drawings are not intended to limit the scope of the present teachings in any way.

FIG. 1 is a block diagram that illustrates a computer system, upon which embodiments of the present teachings may be implemented.

FIG. 2 is an exemplary plot of a single precursor ion mass selection window that is typically used in a SWATH acquisition.

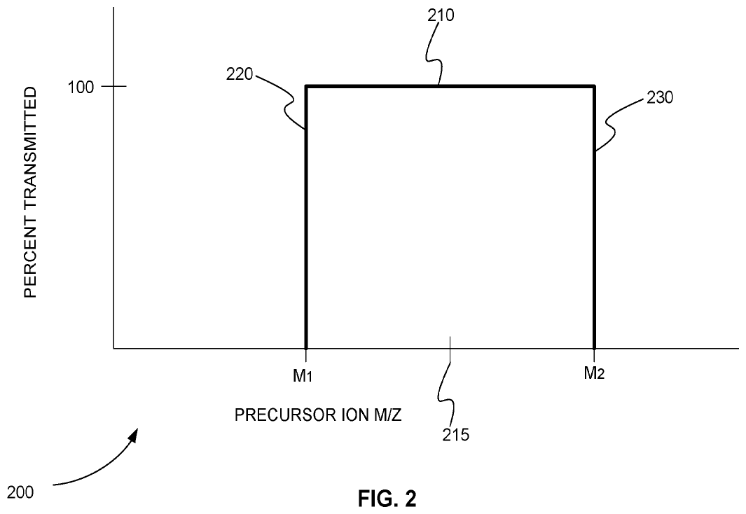

FIG. 3 is an exemplary series 3 of plots showing how product ions are correlated to precursor ions in conventional SWATH.

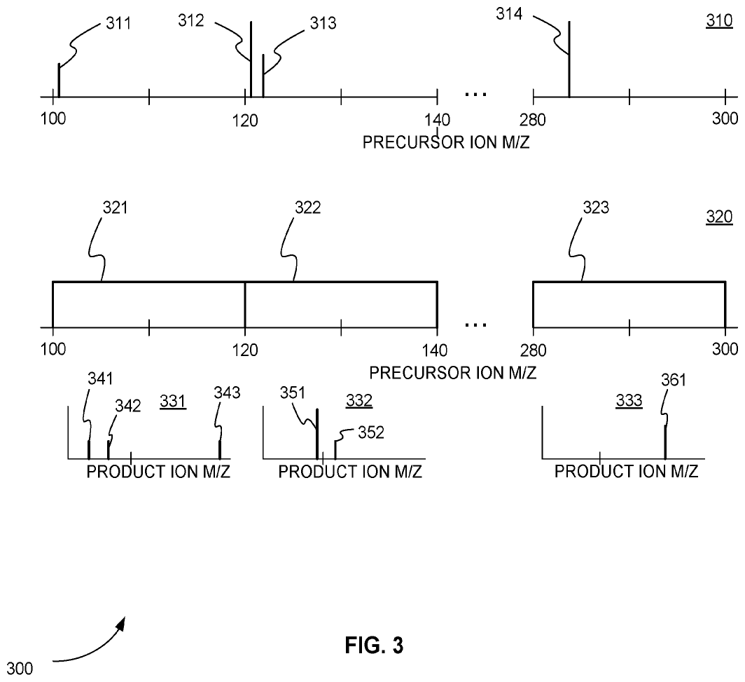

FIG. 4 is an exemplary plot of a precursor ion mass selection window that is shifted or scanned across a precursor ion mass range in order to produce overlapping precursor ion mass selection windows.

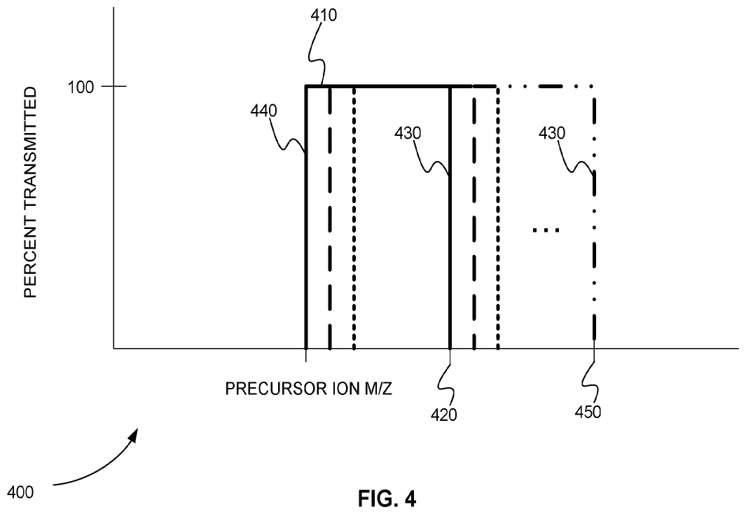

FIG. 5 is an exemplary series of plots showing how product ions are correlated to precursor ions in scanning SWATH.

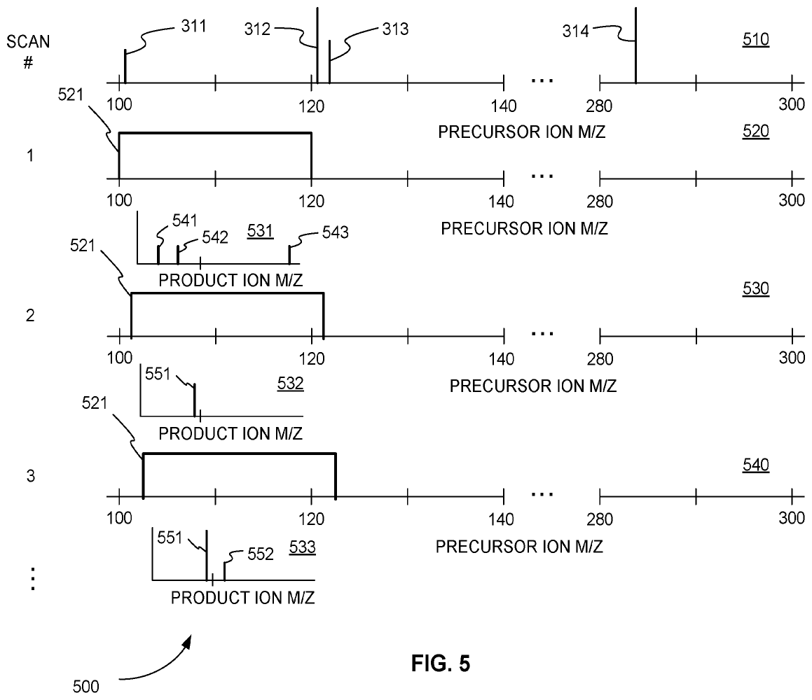

FIG. 6 is a diagram showing how a product ion produced from a precursor ion that is filtered by overlapping precursor ion mass selection windows in a scanning SWATH acquisition can be plotted as a function of the precursor ion mass selection window moving across the precursor mass range.

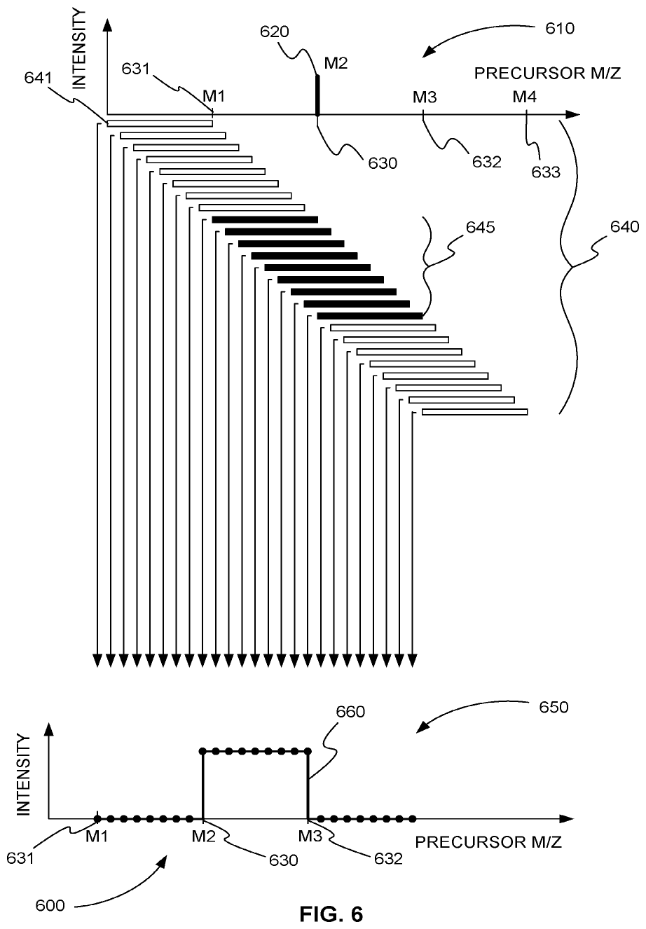

FIG. 7 is a plot of an exemplary quadrupole ion trace (QIT) calculated for a selected product ion that is produced from two interfering precursor ions using data from an actual scanning SWATH experiment.

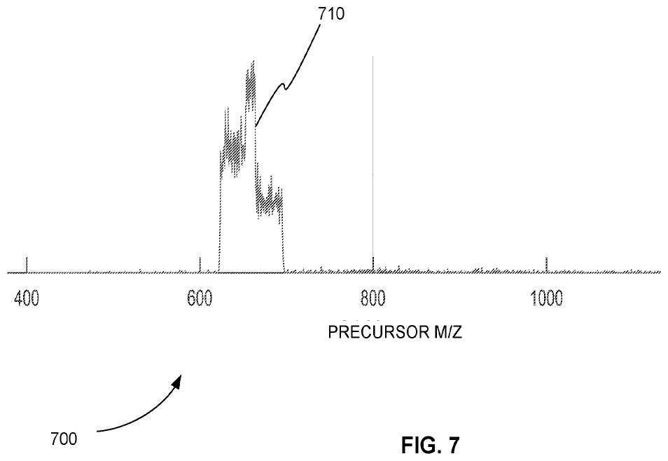

FIG. 8 is a diagram showing a simplified example of how corresponding precursor ions are determined from a product ion QIT using a system of linear equations represented by a matrix multiplication equation.

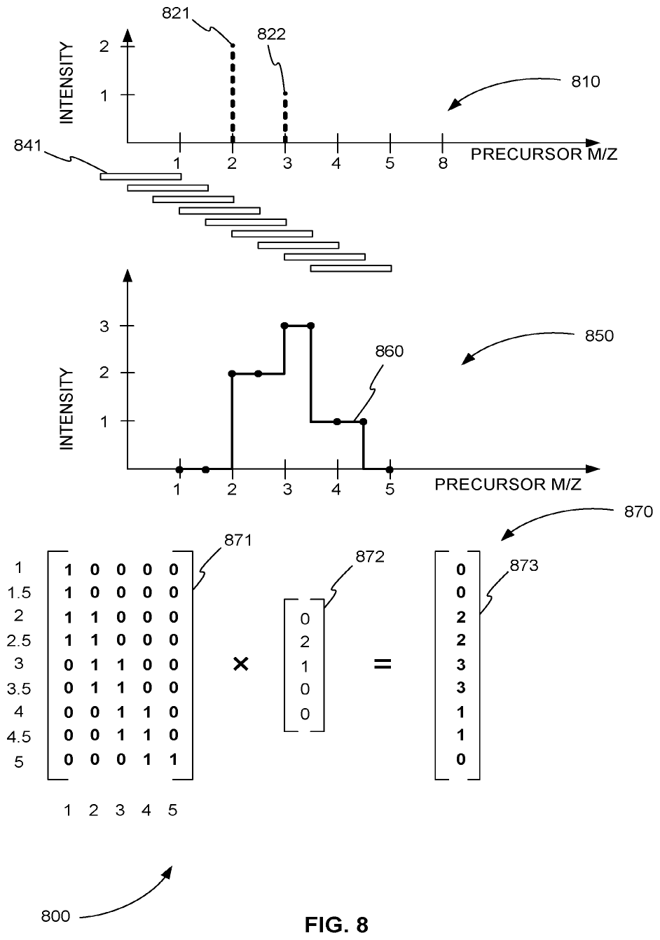

FIG. 9 is an exemplary matrix multiplication equation showing an experimental example of how corresponding precursor ions are determined from a product ion QIT.

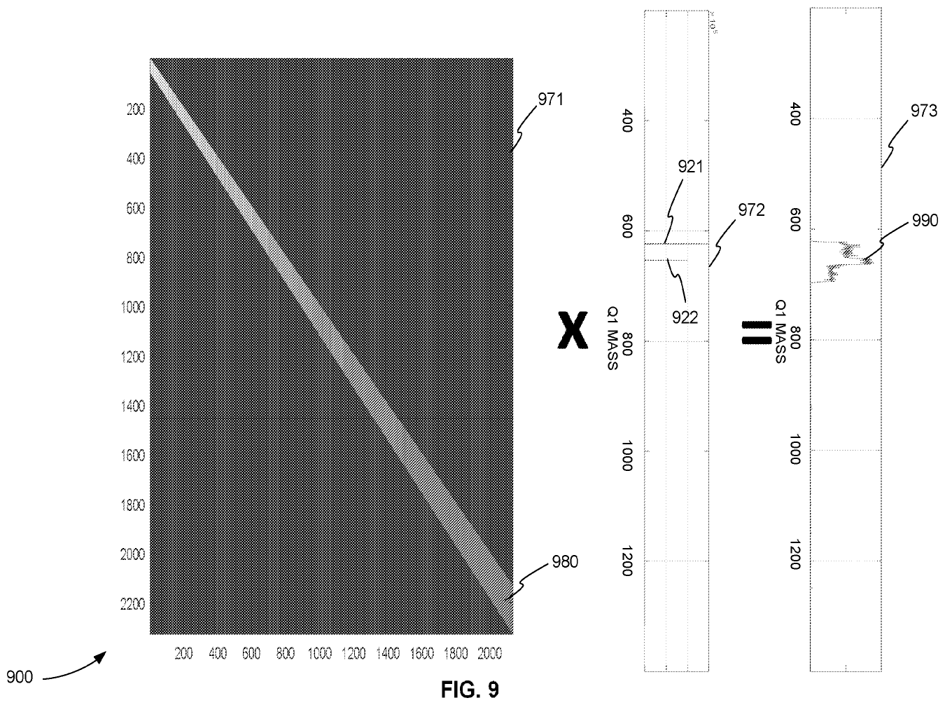

FIG. 10 is a schematic diagram showing a mass spectrometry system, in accordance with various embodiments.

FIG. 11 is an exemplary precursor ion spectrum produced from a precursor ion survey scan of a DDA method showing two precursor ion peaks that were found, in accordance with various embodiments.

FIG. 12 is an exemplary diagram showing how a precursor ion is selected and fragmented in a DDA method in order to deconvolve the precursor ion and product ion relationships in a product ion spectrum in a single time cycle, in accordance with various embodiments.

FIG. 13 is a flowchart showing a method for performing a DDA mass spectrometry experiment, in accordance with various embodiments.

FIG. 14 is a schematic diagram of a system that includes one or more distinct software modules that performs a method for performing a DDA experiment, in accordance with various embodiments.

Before one or more embodiments of the present teachings are described in detail, one skilled in the art will appreciate that the present teachings are not limited in their application to the details of construction, the arrangements of components, and the arrangement of steps set forth in the following detailed description or illustrated in the drawings. Also, it is to be understood that the phraseology and terminology used herein is for the purpose of description and should not be regarded as limiting.

### DESCRIPTION OF VARIOUS EMBODIMENTS

### Computer-Implemented System

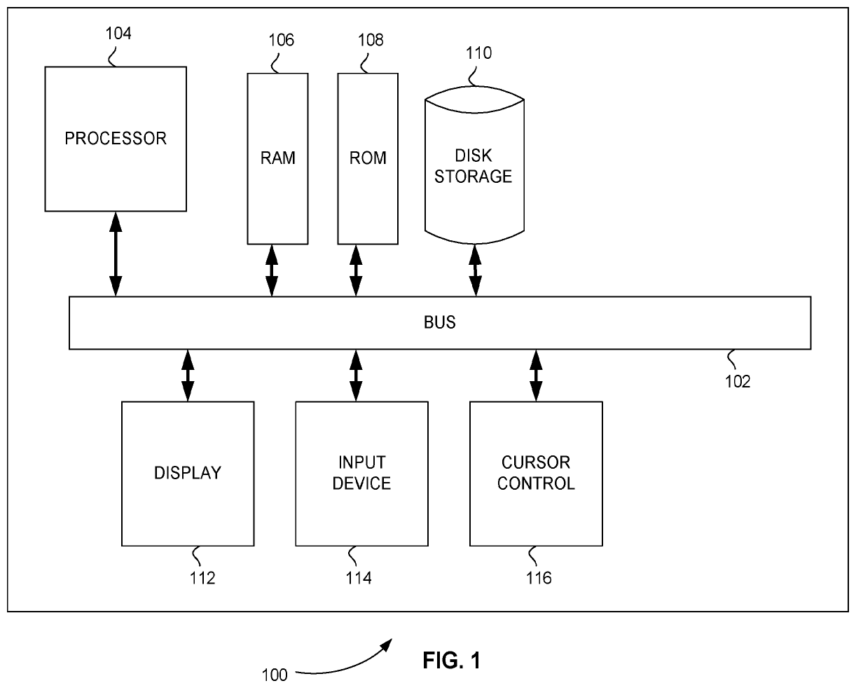

FIG. 1 is a block diagram that illustrates a computer system 100, upon which embodiments of the present teachings may be implemented. Computer system 100 includes a bus 102 or other communication mechanism for communicating information, and a processor 104 coupled with bus 102 for processing information. Computer system 100 also includes a memory 106, which can be a random access memory (RAM) or other dynamic storage device, coupled to bus 102 for storing instructions to be executed by processor 104. Memory 106 also may be used for storing temporary variables or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT) or liquid crystal display (LCD), for displaying information to a computer user. An input device 114, including alphanumeric and other keys, is coupled to bus 102 for communicating information and command selections to processor 104. Another type of user input device is cursor control 116, such as a mouse, a trackball or cursor direction keys for communicating direction information and command selections to processor 104 and for controlling cursor movement on display 112. This input device typically has two degrees of freedom in two axes, a first axis (i.e., x) and a second axis (i.e., y), that allows the device to specify positions in a plane.

A computer system 100 can perform the present teachings. Consistent with certain implementations of the present teachings, results are provided by computer system 100 in response to processor 104 executing one or more sequences of one or more instructions contained in memory 106. Such instructions may be read into memory 106 from another computer-readable medium, such as storage device 110. Execution of the sequences of instructions contained in memory 106 causes processor 104 to perform the process described herein. Alternatively, hard-wired circuitry may be used in place of or in combination with software instructions to implement the present teachings. Thus implementations of the present teachings are not limited to any specific combination of hardware circuitry and software.

The term “computer-readable medium” as used herein refers to any media that participates in providing instructions to processor 104 for execution. Such a medium may take many forms, including but not limited to, non-volatile media, volatile media, and precursor ion mass selection media. Non-volatile media includes, for example, optical or magnetic disks, such as storage device 110. Volatile media includes dynamic memory, such as memory 106. Precursor ion mass selection media includes coaxial cables, copper wire, and fiber optics, including the wires that comprise bus 102.

Common forms of computer-readable media include, for example, a floppy disk, a flexible disk, hard disk, magnetic tape, or any other magnetic medium, a CD-ROM, digital video disc (DVD), a Blu-ray Disc, any other optical medium, a thumb drive, a memory card, a RAM, PROM, and EPROM, a FLASH-EPROM, any other memory chip or cartridge, or any other tangible medium from which a computer can read.

Various forms of computer readable media may be involved in carrying one or more sequences of one or more instructions to processor 104 for execution. For example, the instructions may initially be carried on the magnetic disk of a remote computer. The remote computer can load the instructions into its dynamic memory and send the instructions over a telephone line using a modem. A modem local to computer system 100 can receive the data on the telephone line and use an infra-red transmitter to convert the data to an infra-red signal. An infra-red detector coupled to bus 102 can receive the data carried in the infra-red signal and place the data on bus 102. Bus 102 carries the data to memory 106, from which processor 104 retrieves and executes the instructions. The instructions received by memory 106 may optionally be stored on storage device 110 either before or after execution by processor 104.

In accordance with various embodiments, instructions configured to be executed by a processor to perform a method are stored on a computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed.

The following descriptions of various implementations of the present teachings have been presented for purposes of illustration and description. It is not exhaustive and does not limit the present teachings to the precise form disclosed. Modifications and variations are possible in light of the above teachings or may be acquired from practicing of the present teachings. Additionally, the described implementation includes software but the present teachings may be implemented as a combination of hardware and software or in hardware alone. The present teachings may be implemented with both object-oriented and non-object-oriented programming systems.

### Using Scanning Sequential Windows in DDA MS/MS

As described above, current DDA methods rely upon the fact that a narrow precursor ion mass selection window can isolate a single precursor ion representing a single compound for fragmentation. If the single product ion spectrum used for identification of the compound, however, contains product ions from more than one precursor ion, the precursor ion and product ion relationships must be deconvolved. If product ion spectra are collected over time, for example, these relationships can be deconvolved using the known retention times of known compounds. Unfortunately, however, there is no method and insufficient data to deconvolve the precursor ion and product ion relationships in the same time cycle. As a result, there is a need for systems and methods that can deconvolve the precursor ion and product ion relationships in a product ion spectrum of a DDA method in a single time cycle.

In order to provide an orthogonal dimension to the product ion spectra of DDA and to enable deconvolution, a number of methods have been proposed in the past. These methods include the use of collision energy (CE) ramps and full store mode in time-of-flight (TOF) instruments, the use of modulating source parameters in TOF instruments, automatically repeating the MS/MS a number of times after first detection and using principal component analysis followed by variable grouping (PCVG) for deconvolution, and automatically deciding the number of repeats of an MS/MS scan based on the number of co-isolating precursor ions. This prior art shows that the issue of co-isolation is complex and there are a variety of methods available for performing deconvolution.

Various embodiments differ from the prior art in that they use a narrow Q1 mass range (10 Da Q1 mass range centered on the selected precursor mass) and use a fast scan of the isolation quadrupole across this mass range with an isolation window of 0.5-1.5 Da in size. Collision energy (CE) is applied during the fast Q1 scan using current rolling CE parameters defined by the expected charge and mass of the parent mass. During the Q1 mass range scan, all TOF pulses are recorded providing a data stream that is coupled to the exact Q1 transmission parameters. The resulting data is then be processed in a targeted manner where the parent mass is correlated to the fragment masses in Q1 dimension and the confidence of a fragment ion being associated with a specific parent mass determined.

Various algorithms for the deconvolution and storage of the data, such as those described above, are used. Although the enhancements of scanning SWATH where a multidimensional surface of Q1 and chromatographic time are used to fully deconvolve data have been used in the past, in the various embodiments described herein, time is not a factor that is used in the deconvolution.

In other words, in various embodiments, scanning SWATH is applied during the MS/MS isolation and fragmentation of a precursor ion in DDA to deconvolve the precursor ion and product ion relationships in the resulting product ion spectrum in a single time cycle. A single time cycle is, for example, the time it takes to perform a precursor ion survey and then fragment and mass analyze the precursor ions of an entire precursor ion mass range once in a DDA method. Scanning SWATH has previously been used in a DDA method. However, it has not previously been used during the MS/MS isolation and fragmentation of a precursor ion.

In U.S. Pat. No. 11,069,517 (hereinafter “the '517 patent”) scanning SWATH is performed during the precursor ion survey scan to filter out contaminants. These contaminants can include fragments or product ions of the precursor ions that are produced by some form of unintentional spontaneous fragmentation within the mass spectrometer. These contaminants can also include adducts that are produced when precursor ions pick up unexpected additional molecular material from within the mass spectrometer. As a result, the '517 patent is directed to applying scanning SWATH to a different part of the DDA method to address a different problem than the embodiments described herein.

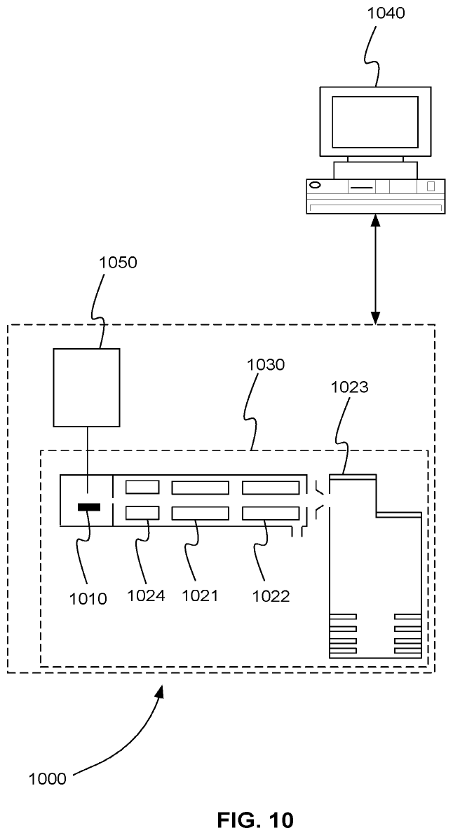

FIG. 10 is a schematic diagram showing a mass spectrometry system 1000, in accordance with various embodiments. System 1000 of FIG. 10 includes ion source device 1010, tandem mass spectrometer 1030, and processor 1040. Tandem mass spectrometer 1030 includes mass filter 1021, fragmentation device 1022, and mass analyzer 1023. System 1000 further optionally includes sample introduction device 1050 and ion focusing device 1024. One skilled in the art will understand that, in a quadrupole-based system, ion focusing device 1024, mass filter 1021, and fragmentation device 1022 can be referred to as Q₀, Q₁, and Q₂, respectively.

Ideally in a precursor ion survey scan, precursor ions produced by ion source device 1010 are focused by ion focusing device 1024, transported without fragmentation by fragmentation device 1022 from mass filter 1021 to mass analyzer 1023, and mass analyzed by mass analyzer 1023. As described above, however, in modern mass spectrometers, the sensitivity is such that a number of precursor ions representing different compounds can be measured near the same mass and then co-isolated for fragmentation.

A precursor ion survey scan is often referred to as a low-energy scan. This means that fragmentation device 1022 is given enough CE to move the selected precursor ions through it, but not enough CE to cause intentional fragmentation of the selected precursor ions. The selected precursor ions are moved through fragmentation device 1022 so they can be sent to mass analyzer 1023. Mass analyzer 1023 measures the m/z mass-to-charge ratio (m/z) of the selected precursor ions and produces a precursor ion spectrum.

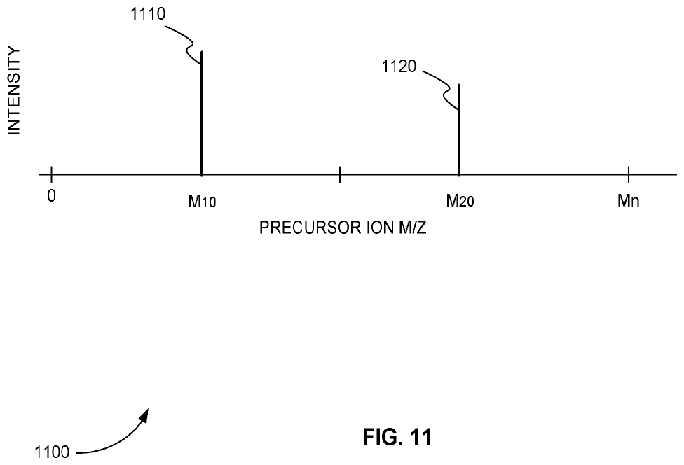

FIG. 11 is an exemplary precursor ion spectrum 1100 produced from a precursor ion survey scan of a DDA method showing two precursor ion peaks that were found, in accordance with various embodiments. Precursor ion spectrum 1100 includes peak 1110 at M₁₀ m/z and peak 1120 at M₂₀ m/z across mass range 0 to Mₙ. From precursor ion spectrum 1100, peak 1110 and peak 1120 are selected for the peak list of the DDA method.

In a DDA experiment, there is no prior knowledge about the precursor ions in the precursor ion mass range between 0 m/z and Mₙ m/z. As a result, it is not known if peak 1110 and peak 1120 are actually the only precursor ions in the mass range. Also, a precursor ion survey scan is a low-resolution scan, so it is not known if there are any precursor ions close to peak 1110 and peak 1120 that are not resolved in the precursor ion survey scan.

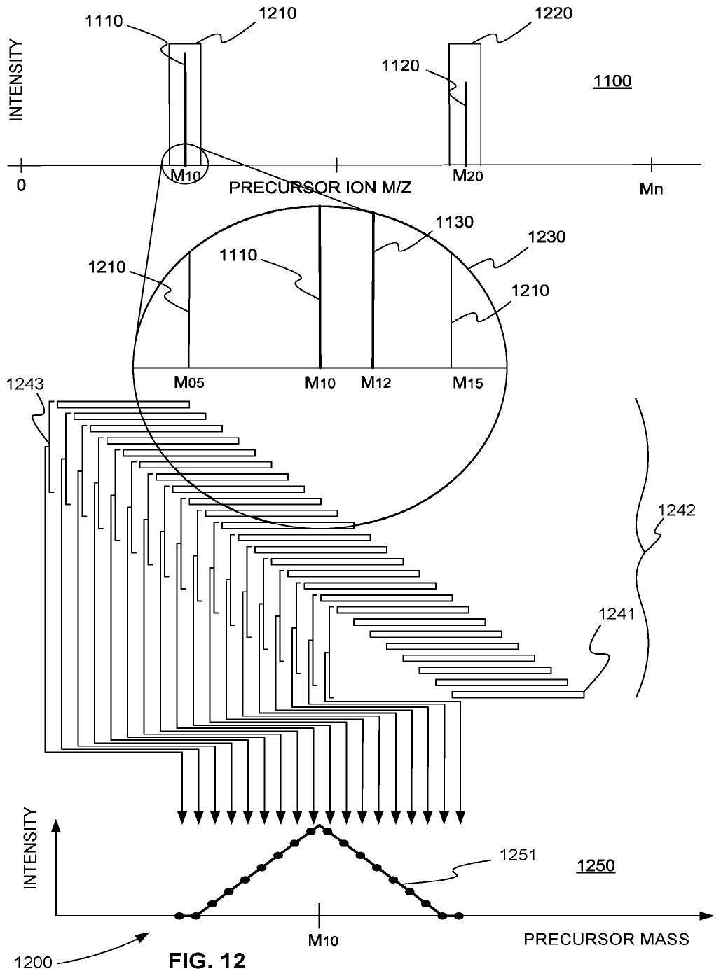

FIG. 12 is an exemplary diagram 1200 showing how a precursor ion is selected and fragmented in a DDA method in order to deconvolve the precursor ion and product ion relationships in a product ion spectrum in a single time cycle, in accordance with various embodiments. FIG. 12 includes precursor ion spectrum 1100 of FIG. 11. As described above, from the precursor ion survey scan, peak 1110 and peak 1120 are selected for the peak list of the DDA method.

In a conventional DDA method, peak 1110 and peak 1120 are separately mass filtered and fragmented using a narrow precursor ion mass selection window. One skilled in the art understands that mass filtering can also be referred to as scanning, selecting, or isolating. For example, peak 1110 is mass filtered using precursor ion mass selection window 1210, and peak 1120 is mass filtered using precursor ion mass selection window 1220.

Inset 1230 shows that precursor ion mass selection window 1210 can include an additional peak 1130 that can be measured with high sensitivity or resolution near peak 1110. As a result, if precursor ion mass selection window 1210 is used, peak 1120 and peak 1130 are co-isolated for fragmentation and the resulting product ion spectrum of precursor ion mass selection window 1210 includes product ions of both peaks. Consequently, the precursor ion and product ion relationships must be deconvolved in order to identify peak 1110.

In various embodiments, in order to deconvolve precursor ion and product ion relationships and identify peak 1110, a peak mass range is selected for peak 1110. This peak mass range is, for example, M₀₅ m/z to M₁₅ m/z. A mass filter of the mass spectrometer is then controlled or operated to scan a precursor ion mass selection window 1241 with a width smaller than the peak mass range across the peak mass range in overlapping steps, producing a series of overlapping precursor ion mass selection windows 1242 across the peak mass range. Note that, although precursor ion mass selection window 1241 is shown in FIG. 12 as being scanned in discrete steps, this scanning can also be accomplished as or thought of as a continuous scan of precursor ion mass selection window 1241 across the peak mass range.

A fragmentation device of the mass spectrometer is controlled or operated to fragment each precursor ion mass selection window 1241 of series of overlapping precursor ion mass selection windows 1242. A mass analyzer is controlled or operated to mass analyze product ions produced from each overlapping precursor ion mass selection window 1241, producing a product ion spectrum for each overlapping precursor ion mass selection window 1241 for peak 1110.

In various embodiments, the precursor ion and product ion relationships for peak 1110 and peak 1130 are deconvolved using the product ion spectra produced for series of overlapping precursor ion mass selection windows 1242. For example, these relationships can be deconvolved using the systems and methods of the '019 patent.

In various alternative embodiments, these relationships can also be deconvolved using the systems and methods of the '753 patent. FIG. 12 depicts the deconvolution method of the '753 patent. In this method, successive groups 1243 of windows 1241 are selected. The product ion intensities from spectra from the successive groups 1243 of windows 1241 are summed. This summing produces plot 1250. Plot 1250 shows that a product ion of precursor ion 1110 acquires a triangular-shaped function 1251 of product ion intensity with respect to precursor mass. Plot 1250 also shows that the apex or center of gravity of function 1251 points to M₁₀ m/z of precursor ion 1110.

Similarly, a plot of a product ion of precursor ion 1130 using the method of the '753 patent would also produce a triangular-shaped function. However, the apex or center of gravity of that function would point to M₁₂ m/z of precursor ion 1130. Thus, using the summed intensities of successive groups of windows 1241, each product ion produced from peak mass range M₀₅ m/z to M₁₅ m/z is deconvolved and its precursor ion is determined.

In FIG. 12, only series of overlapping precursor ion mass selection windows 1242 used for peak 1110 is shown. A similar series of overlapping precursor ion mass selection windows, however, would also be used for a peak mass range around peak 1120. In other words, a series of overlapping precursor ion mass selection windows is applied to a mass range around each precursor ion peak of the peak list in order to isolate and fragment each precursor ion in the DDA method.

### System for Performing a DDA Experiment

Returning to FIG. 10, FIG. 10 shows system 1000 for performing a DDA mass spectrometry experiment, in accordance with various embodiments. System 1000 of FIG. 10 includes ion source device 1010, tandem mass spectrometer 1030, and processor 1040. Tandem mass spectrometer 1030 includes mass filter 1021, fragmentation device 1022, and mass analyzer 1023. In various embodiments, ion source device 1010 can be part of tandem mass spectrometer 1030 or a separate device. In various embodiments, tandem mass spectrometer 1030 also includes focusing device 1024, which can be, for example, a Q₀ quadrupole.

In various embodiments, system 1000 can further include sample introduction device 1050. Sample introduction device 1050 introduces one or more compounds of interest from a sample to ion source device 1010 over time, for example. Sample introduction device 1050 can perform techniques that include, but are not limited to, injection, liquid chromatography, gas chromatography, capillary electrophoresis, or ion mobility.

In system 1000, mass filter 1021 and fragmentation device 1022 are shown as different stages of a triple quadrupole and mass analyzer 1023 is shown as a time-of-flight (TOF) device. One of ordinary skill in the art can appreciate that any of these stages can include other types of mass spectrometry devices including, but not limited to, ion traps, orbitraps, ion mobility devices, or Fourier transform ion cyclotron resonance (FT-ICR) devices.

Ion source device 1010 transforms a sample or compounds of interest from a sample provided by sample introduction device 1050 into an ion beam. Ion source device 1010 can perform ionization techniques that include, but are not limited to, matrix assisted laser desorption/ionization (MALDI) or electrospray ionization (ESI).

Tandem mass spectrometer 1030 creates precursor ion peak list of a DDA experiment. It does this by transmitting a mass range of precursor ions from the ion beam, measuring a precursor ion mass spectrum for the mass range using mass analyzer 1023, and selecting one or more peaks of the mass spectrum for the peak list.

For each precursor ion peak of the peak list, tandem mass spectrometer 1030 performs a number of steps. First, tandem mass spectrometer 1030 selects a peak mass range including the precursor ion peak. Second, tandem mass spectrometer 1030 scans a precursor ion mass selection window with a width smaller than the peak mass range across the peak mass range in overlapping steps using mass filter 1021, producing a series of overlapping precursor ion mass selection windows across the peak mass range. Third, tandem mass spectrometer 1030 fragments each overlapping precursor ion mass selection window of the series using fragmentation device 1022. Finally, tandem mass spectrometer 1030 mass analyzes product ions produced from each overlapping precursor ion mass selection window of the series using mass analyzer 1023. A product ion spectrum for each overlapping precursor ion mass selection window of the series is produced and a plurality of product ion spectra are produced for the peak.

In various embodiments, mass filter 1021 is a quadrupole. In various embodiments, mass analyzer 1023 is a quadrupole or a time-of-flight (TOF) mass analyzer.

Processor 1040 can be, but is not limited to, a computer, a microprocessor, the computer system of FIG. 1, or any device capable of sending and receiving control signals and data to and from tandem mass spectrometer 1030 and processing data. Processor 1040 is in communication with ion source device 1010, mass filter 1021, fragmentation device 1022, and mass analyzer 1023.

In various embodiments, processor 1040 is used to identify a precursor ion of product ion from the plurality of product ion spectra that are produced for a precursor ion peak. Specifically, for each precursor ion peak of the peak list, processor 1040 performs a number of steps. First, processor 1040 receives the plurality of product ion spectra. Processor 1040 then, for at least one product ion of the plurality of product ion spectra, calculates a function that describes how an intensity of the at least one product ion from the plurality of product ion spectra varies with precursor ion mass as the precursor ion mass selection window is stepped across a peak mass range. Finally, processor 1040 identifies a precursor ion of the at least one product ion from the function.

In various embodiments and as shown in FIG. 12, processor 1040 further, for each precursor ion peak of the peak list, combines groups of product ion spectra from the plurality of product ion spectra to produce the function that has a shape that is non-constant with precursor mass.

In various embodiments and as shown in FIG. 12, the shape can be a triangle.

In various embodiments, processor 1040 identifies a precursor ion of the at least one product ion from the function by calculating a parameter of a shape of the function.

In various embodiments, the parameter comprises a center of gravity of the shape.

In various embodiments, the parameter comprises an apex of the shape.

In various embodiments, processor 1040 is used to identify a precursor ion of product ion from the plurality of product ion spectra using a matrix multiplication equation. Specifically, for each precursor ion peak of the peak list, processor 1040 performs a number of steps. First, processor 1040 receives the plurality of product ion spectra. Processor 1040 selects at least one product ion from the plurality of product ion spectra that has an intensity above a predetermined threshold. For the selected product ion, processor 1040 retrieves the intensities of the selected product ion from the plurality of product ion spectra for at least one scan of the precursor ion mass selection window across the peak mass range. A trace that describes how the intensity of the selected product ion varies with precursor ion mass-to-charge ratio (m/z) as the precursor ion mass selection window is scanned across the peak mass range is produced. Processor 1040 creates a matrix multiplication equation that describes how one or more precursor ions corresponds to the trace for the selected product ion, wherein the matrix multiplication equation includes a known n×m mass filter matrix multiplied by an unknown precursor ion column matrix of length m that equates to a selected ion trace column matrix of length n. Finally, processor 1040 solves the matrix multiplication equation for the unknown precursor ion column matrix using a numerical method, producing intensities for one or more precursor ion m/z values corresponding to the selected product ion.

In various embodiments, the numerical method includes non-negative least squares (NNLS).

In various embodiments, rows, n, of the mass filter matrix are the locations of the precursor ion mass selection window across the peak mass range, the columns, m, of the mass filter matrix are the precursor ion m/z values across the peak mass range, and the elements of the mass filter matrix represent the transmission or non-transmission by the precursor ion mass selection window. Rows, m, of the unknown precursor ion column matrix correspond to the columns of the mass filter matrix and are the precursor ion m/z values across the peak mass range, and the elements of the unknown precursor ion column matrix are the intensities of the precursor ions corresponding to the selected product ion. Rows, n, of the trace column matrix correspond to the rows of the mass filter matrix and are the locations of the precursor ion mass selection window across the peak mass range, and the elements of the trace column matrix are the intensities of the selected product ion at locations of the precursor ion mass selection window across the peak mass range.

### Method for Performing a DDA Experiment

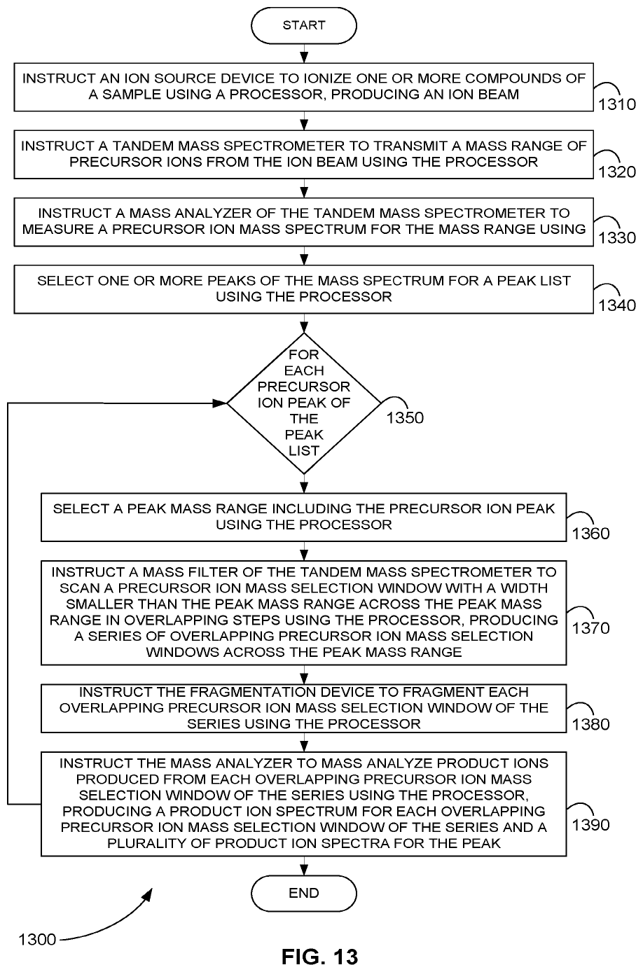

FIG. 13 is a flowchart 1300 showing a method for performing a DDA mass spectrometry experiment, in accordance with various embodiments.

In step 1310 of method 1300, an ion source device is instructed to ionize one or more compounds of a sample using a processor, producing an ion beam.

In step 1320, a tandem mass spectrometer is instructed to transmit a mass range of precursor ions from the ion beam using the processor.

In step 1330, a mass analyzer of the tandem mass spectrometer is instructed to measure a precursor ion mass spectrum for the mass range using the processor.

In step 1340, one or more peaks of the mass spectrum are selected for a peak list using the processor.

In step 1350, a series of steps are performed for each precursor ion peak of the peak list.

In step 1360, a peak mass range including the precursor ion peak is selected using the processor.

In step 1370, a mass filter of the tandem mass spectrometer is instructed to scan a precursor ion mass selection window with a width smaller than the peak mass range across the peak mass range in overlapping steps using the processor, producing a series of overlapping precursor ion mass selection windows across the peak mass range.

In step 1380, the fragmentation device is instructed to fragment each overlapping precursor ion mass selection window of the series using the processor.

In step 1390, the mass analyzer is instructed to mass analyze product ions produced from each overlapping precursor ion mass selection window of the series using the processor, producing a product ion spectrum for each overlapping precursor ion mass selection window of the series and a plurality of product ion spectra for the peak.

### Computer Program Product for Performing a DDA Experiment

In various embodiments, a computer program product includes a non-transitory tangible computer-readable storage medium whose contents include a program with instructions being executed on a processor so as to perform a DDA experiment. This method is performed by a system that includes one or more distinct software modules.

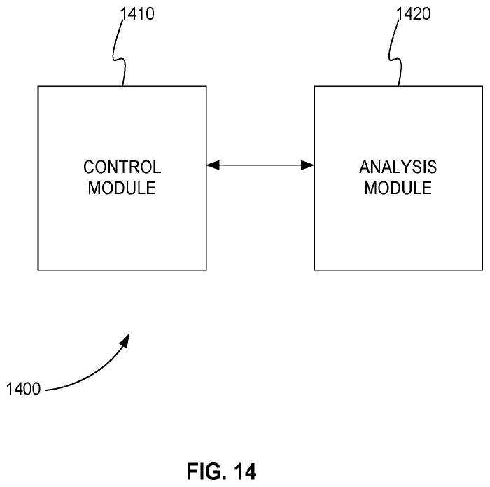

FIG. 14 is a schematic diagram of a system 1400 that includes one or more distinct software modules that performs a method for performing a DDA experiment, in accordance with various embodiments. System 1400 includes control module 1410 and analysis module 1420.

Control module 1410 instructs an ion source device to ionize one or more compounds of a sample, producing an ion beam. Control module 1410 instructs a tandem mass spectrometer to transmit a mass range of precursor ions from the ion beam. Control module 1410 instructs a mass analyzer of the tandem mass spectrometer to measure a precursor ion mass spectrum for the mass range.

Analysis module 1420 selects one or more peaks of the mass spectrum for a peak list.

For each precursor ion peak of the peak list, a number of steps are performed. Analysis module 1420 selects a peak mass range including the precursor ion peak. Control module 1410 instructs a mass filter of the tandem mass spectrometer to scan a precursor ion mass selection window with a width smaller than the peak mass range across the peak mass range in overlapping steps. A series of overlapping precursor ion mass selection windows across the peak mass range are produced.

Control module 1410 instructs the fragmentation device to fragment each overlapping precursor ion mass selection window of the series. Control module 1410 instructs the mass analyzer to mass analyze product ions produced from each overlapping precursor ion mass selection window of the series. A product ion spectrum is produced for each overlapping precursor ion mass selection window of the series and a plurality of product ion spectra are produced for the peak.

While the present teachings are described in conjunction with various embodiments, it is not intended that the present teachings be limited to such embodiments. On the contrary, the present teachings encompass various alternatives, modifications, and equivalents, as will be appreciated by those of skill in the art.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments.

1. A system for performing a data-dependent acquisition (DDA) mass spectrometry experiment, comprising:
an ion source device that ionizes one or more compounds of a sample, producing an ion beam;
a tandem mass spectrometer that includes a mass filter device, a fragmentation device, and a mass analyzer, that creates precursor ion peak list of an DDA experiment by transmitting a mass range of precursor ions from the ion beam, measuring a precursor ion mass spectrum for the mass range using the mass analyzer, and selecting one or more peaks of the mass spectrum for the peak list, and that
for each precursor ion peak of the peak list,
selects a peak mass range including the precursor ion peak,
scans a precursor ion mass selection window with a width smaller than the peak mass range across the peak mass range in overlapping steps using the mass filter, producing a series of overlapping precursor ion mass selection windows across the peak mass range,
fragments each overlapping precursor ion mass selection window of the series using the fragmentation device, and
mass analyzes product ions produced from each overlapping precursor ion mass selection window of the series using the mass analyzer, producing a product ion spectrum for each overlapping precursor ion mass selection window of the series and a plurality of product ion spectra for the peak.

2. The system of claim 1, further comprising a processor in communication with the mass filter, fragmentation device, and the mass analyzer that for each precursor ion peak of the peak list,
receives the plurality of product ion spectra,
for at least one product ion of the plurality of product ion spectra, calculates a function that describes how an intensity of the at least one product ion from the plurality of product ion spectra varies with precursor ion mass as the precursor ion mass selection window is stepped across a peak mass range, and
identifies a precursor ion of the at least one product ion from the function.

3. The system of claim 2, wherein the processor further, for each precursor ion peak of the peak list, combines groups of product ion spectra from the plurality of product ion spectra to produce the function that has a shape that is non-constant with precursor mass.

4. The system of claim 3, wherein the shape comprises a triangle.

5. The system of claim 2, wherein the processor identifies a precursor ion of the at least one product ion from the function by calculating a parameter of a shape of the function.

6. The system of claim 5, wherein the parameter comprises a center of gravity of the shape.

7. The system of claim 5, wherein the parameter comprises an apex of the shape.

8. The system of claim 1, wherein the mass filter comprises a quadrupole.

9. The system of claim 1, wherein the mass analyzer comprises a quadrupole.

10. The system of claim 1, wherein the mass analyzer comprises a time-of-flight (TOF) mass analyzer.

11. The system of claim 1, further comprising a processor in communication with the mass filter, fragmentation device, and the mass analyzer that for each precursor ion peak of the peak list,
receives the plurality of product ion spectra,
selects at least one product ion from the plurality of product ion spectra that has an intensity above a predetermined threshold,
for the selected product ion, retrieves the intensities of the selected product ion from the plurality of product ion spectra for at least one scan of the precursor ion mass selection window across the peak mass range, producing a trace that describes how the intensity of the selected product ion varies with precursor ion mass-to-charge ratio (m/z) as the precursor ion mass selection window is scanned across the peak mass range,
creates a matrix multiplication equation that describes how one or more precursor ions corresponds to the trace for the selected product ion, wherein the matrix multiplication equation includes a known n×m mass filter matrix multiplied by an unknown precursor ion column matrix of length m that equates to a selected ion trace column matrix of length n, and
solves the matrix multiplication equation for the unknown precursor ion column matrix using a numerical method, producing intensities for one or more precursor ion m/z values corresponding to the selected product ion.

12. The system of claim 11, wherein the numerical method comprises non-negative least squares (NNLS).

13. The system of claim 11,
wherein rows, n, of the mass filter matrix are the locations of the precursor ion mass selection window across the peak mass range, the columns, m, of the mass filter matrix are the precursor ion m/z values across the peak mass range, and the elements of the mass filter matrix represent the transmission or non-transmission by the precursor ion mass selection window,
wherein rows, m, of the unknown precursor ion column matrix correspond to the columns of the mass filter matrix and are the precursor ion m/z values across the peak mass range, and the elements of the unknown precursor ion column matrix are the intensities of the precursor ions corresponding to the selected product ion, and
wherein the rows, n, of the trace column matrix correspond to the rows of the mass filter matrix and are the locations of the precursor ion mass selection window across the peak mass range, and the elements of the trace column matrix are the intensities of the selected product ion at locations of the precursor ion mass selection window across the peak mass range.

14. A method for performing a data-dependent acquisition (DDA) mass spectrometry experiment, comprising:
instructing an ion source device to ionize one or more compounds of a sample using a processor, producing an ion beam;
instructing a tandem mass spectrometer to transmit a mass range of precursor ions from the ion beam using the processor;
instructing a mass analyzer of the tandem mass spectrometer to measure a precursor ion mass spectrum for the mass range using the processor,
selecting one or more peaks of the mass spectrum for a peak list using the processor; and for each precursor ion peak of the peak list,
selecting a peak mass range including the precursor ion peak using the processor,
instructing a mass filter of the tandem mass spectrometer to scan a precursor ion mass selection window with a width smaller than the peak mass range across the peak mass range in overlapping steps using the processor, producing a series of overlapping precursor ion mass selection windows across the peak mass range,
instructing the fragmentation device to fragment each overlapping precursor ion mass selection window of the series using the processor, and
instructing the mass analyzer to mass analyze product ions produced from each overlapping precursor ion mass selection window of the series using the processor, producing a product ion spectrum for each overlapping precursor ion mass selection window of the series and a plurality of product ion spectra for the peak.

15. A computer program product, comprising a non-transitory and tangible computer-readable storage medium whose contents include a program with instructions being executed on a processor so as to perform a method for performing a data-dependent acquisition (DDA) mass spectrometry experiment, the method comprising:
providing a system, wherein the system comprises one or more distinct software modules, and wherein the distinct software modules comprise a control module and an analysis module;
instructing an ion source device to ionize one or more compounds of a sample using the control module, producing an ion beam;
instructing a tandem mass spectrometer to transmit a mass range of precursor ions from the ion beam using the control module;
instructing a mass analyzer of the tandem mass spectrometer to measure a precursor ion mass spectrum for the mass range using the control module,
selecting one or more peaks of the mass spectrum for a peak list using the analysis module; and
for each precursor ion peak of the peak list,
selecting a peak mass range including the precursor ion peak using the analysis module,
instructing a mass filter of the tandem mass spectrometer to scan a precursor ion mass selection window with a width smaller than the peak mass range across the peak mass range in overlapping steps using the control module, producing a series of overlapping precursor ion mass selection windows across the peak mass range,
instructing the fragmentation device to fragment each overlapping precursor ion mass selection window of the series using the control module, and
instructing the mass analyzer to mass analyze product ions produced from each overlapping precursor ion mass selection window of the series using the control module, producing a product ion spectrum for each overlapping precursor ion mass selection window of the series and a plurality of product ion spectra for the peak.

16. The method of claim 14, further comprising:
instructing the processor to:
receive the plurality of product ion spectra;
for at least one product ion of the plurality of product ion spectra, calculate a function that describes how an intensity of the at least one product ion from the plurality of product ion spectra varies with precursor ion mass as the precursor ion mass selection window is stepped across a peak mass range; and
identify a precursor ion of the at least one product ion from the function.

17. The method of claim 16, further comprising instruction the processor to identify a precursor ion of the at least one product ion from the function by calculating a parameter of a shape of the function.

18. The method of claim 17, wherein the parameter comprises a center of gravity of the shape.

19. The method of claim 17, wherein the parameter comprises an apex of the shape.

20. The method of claim 14, further comprising instructing a processor, in communication with the mass filter, fragmentation device, and the mass analyzer that for each precursor ion peak of the peak list, to:
receive the plurality of product ion spectra;
select at least one product ion from the plurality of product ion spectra that has an intensity above a predetermined threshold;
for the selected product ion, retrieve the intensities of the selected product ion from the plurality of product ion spectra for at least one scan of the precursor ion mass selection window across the peak mass range, producing a trace that describes how the intensity of the selected product ion varies with precursor ion mass-to-charge ratio (m/z) as the precursor ion mass selection window is scanned across the peak mass range;
create a matrix multiplication equation that describes how one or more precursor ions corresponds to the trace for the selected product ion, wherein the matrix multiplication equation includes a known n×m mass filter matrix multiplied by an unknown precursor ion column matrix of length m that equates to a selected ion trace column matrix of length n; and
solve the matrix multiplication equation for the unknown precursor ion column matrix using a numerical method, producing intensities for one or more precursor ion m/z values corresponding to the selected product ion.
